(19) United States
(12) Patent Application Publication
(10) Pub. No.: US 2008/0068674 A1
(43) Pub. Date: Mar. 20, 2008

(54) AUTOMATED SCANNING OF HARD COPY IMAGES

(76) Inventor: Dale F. McIntyre, Honeoye Falls, NY (US)

Correspondence Address: Pamela R. Crocker;Patent Legal Staff, Eastman Kodak Company, 343 State Street, Rochester, NY, 14650-2201, US

(21) Appl. No.: 11/532,150

(22) Filed: Sep. 15, 2006

(51) Int. Cl. H04N 1/04

(52) U.S. Cl. 358/474

(57) ABSTRACT

A device for automatically scanning multiple images. The device includes a template for forming a sheet for affixing one or more images to be scanned. The device further includes a scanner for sensing data on the sheet and converting the data into scanned image data, and a processor coupled to the scanner for identifying the one or more images from the scanned image data and creating an individual image file for each of the one or more identified images.

### TECHNICAL FIELD

The present invention relates to imaging, and more specifically to the automated scanning of hard copy images.

### BACKGROUND OF THE INVENTION

With the advent of digital imaging and the popularity of the digital camera as a capture device, the primary vehicle for storing and managing digital images has been the personal computer using software such as EasyShare™ software offered by the Eastman Kodak Company. Often such software works cooperatively with online service providers such as the Kodak EasyShare Gallery™. One opportunity to provide a richer digital collection for consumers is the scanning of previously printed photographs such as those produced from silver halide image capture or other hardcopy images that originate from magazines, newspapers or any other source of hardcopy images.

It is well known in the art to use a commercial document scanner in a modified form for the high speed, automated scanning of hard copy images. In such systems, photographic prints or other hard copy images are scanned and saved in a popular image format such as JPEG. The resultant digital image files can also be corrected for skew that occurs in the scanner transport system. The digital image files are then written to a portable storage media such as a CD/DVD format or uploaded to an online service provider such as the Kodak EasyShare Gallery™. Such a system is taught, for example, in U.S. Pat. No. 6,745,186 to Testa et al. This system has an advantage over conventional flatbed scanners by providing an automatic feeding mechanism enabling the scanning of multiple images at very high rates of speed in a single scanning session. The system, however, has limitations on the minimum size of the hardcopy images that the system can successfully handle and scan.

Many hardcopy images such as school pictures or elements of portrait packages include sizes that are outside the range of this scanning system. Furthermore, without copyright consent, consumers attempting to scan these images are denied service, as high-resolution scanning is generally considered outside the scope of personal use. There is a need to automatically handle and scan multiple small hard copy images using high speed, automatic feeding scanner systems. There is also a need to simplify the handling of multiple photographs to be scanned using a flatbed scanner. There is also a need to protect the copyright interests of the copyright owner while balancing the use of the hardcopy image for personal use. Furthermore, there is a need to connect the owner of the copyright with a user to allow the purchase of the rights to the image.

### SUMMARY

In general terms, the present invention is a system and method for automated scanning of hard copy images.

One aspect of the present invention is a method for scanning multiple images, including affixing one or more images to a sheet, scanning the sheet to create scanned image data, identifying the one or more images from the scanned image data, and creating an individual image file for each of the one or more identified images in the scanned image data.

Another aspect of the present invention is a method for printing a sheet suitable for scanning multiple images, including providing a template for forming a sheet for affixing and scanning multiple hard copy images, providing information identifying an individual user account, printing the sheet using the template, and printing the information identifying the individual user account.

Another aspect of the present invention is a system for scanning multiple images, including a sheet for affixing one or more images and creating a scan sheet, a scanner for sensing data on the sheet and converting the data into scanned image data, and a processor coupled to the scanner for identifying the one or more images from the scanned image data and creating an individual image file for each of the one or more identified images.

Yet another aspect of the present invention is a program storage device readable by a computer, tangibly embodying a program of instructions executable by the computer to perform the method steps for causing a scanning of multiple images on scan sheet, including affixing one or more images to a sheet, scanning the sheet to create scanned image data, identifying the one or more images from the scanned image data, and creating an individual image file for each of the one or more identified images in the scanned image data.

### DESCRIPTION OF THE DRAWINGS

FIG. 1 is a system for automatically scanning hard copy images;

FIG. 2A is one embodiment suitable for affixing multiple hard copy images onto a sheet for scanning;

FIG. 2B illustrates an alternative arrangement of a scan sheet suitable for affixing multiple hard copy images;

FIG. 3 illustrates a plurality of hard copy images affixed to a sheet;

FIG. 4 is an alternative embodiment for providing information identifying copyrighted image files;

FIG. 5 illustrates a flow chart for automatically scanning hard copy images affixed to a sheet;

FIG. 6 is a flowchart illustrating the presence of user identification information; and

FIG. 7 is a flowchart illustrating the viewing of copyrighted individual image files.

### DESCRIPTION OF THE PREFERRED EMBODIMENT

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

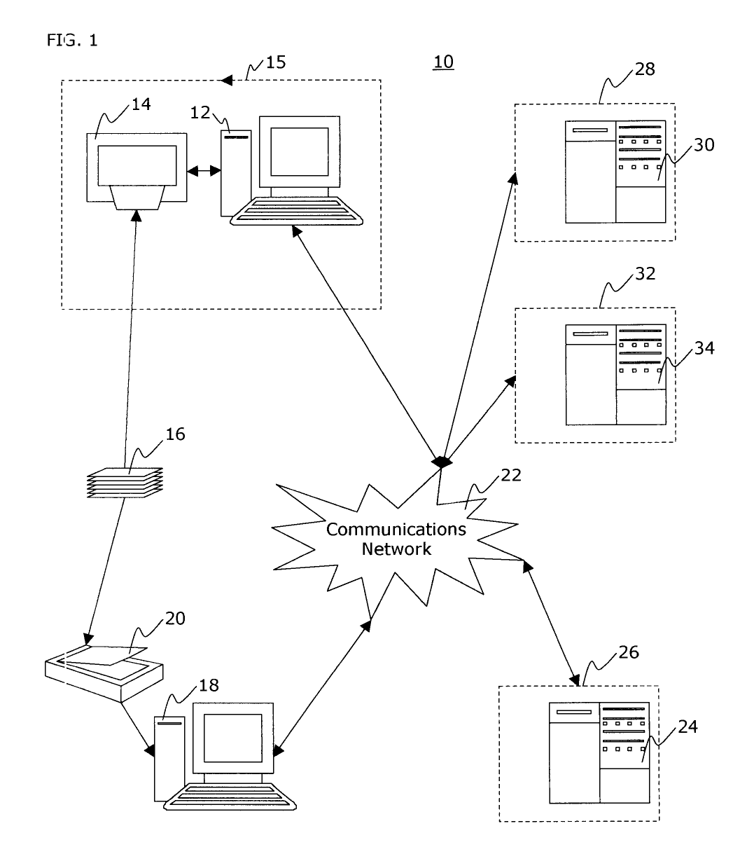

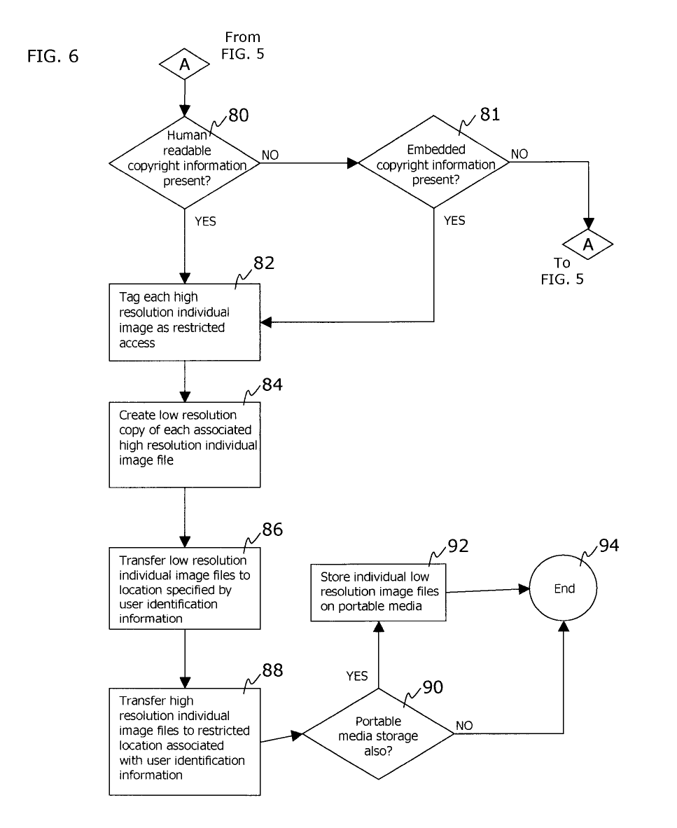

FIG. 1 is a system for automatically scanning hard copy images. The system 10 includes a retailer 15 for providing a high speed, automatic feeding and scanning service using a controlling computer 12 and automated, high speed scanner 14. Retailer 15 is further connected to a communications network 22, such as the Internet, for communicating and transferring digital image files to identified online service providers such as online service provider 26. The online service provider 26 includes a server 24 for storing data, such as the digital image files. Also, coupled to communications network 22 are copyright owners 28, 32 that electronically process requests for copyright purchase and payment with servers 30, 34, respectively. Hard copy images 16 are provided to retailer 15 for scanning and uploading, which will be discussed in more detail with respect to FIG. 6.

In one embodiment, a flatbed scanner 20 is coupled to a personal computer 18 and to the communications network 22 via personal computer 18. In this embodiment, the flatbed scanner 20 doesn't have a minimum size limitation for scanning. The scanning speed is limited by the manual operation of a user placing and replacing very small, hard copy images on the scanning surface of the flatbed scanner 20.

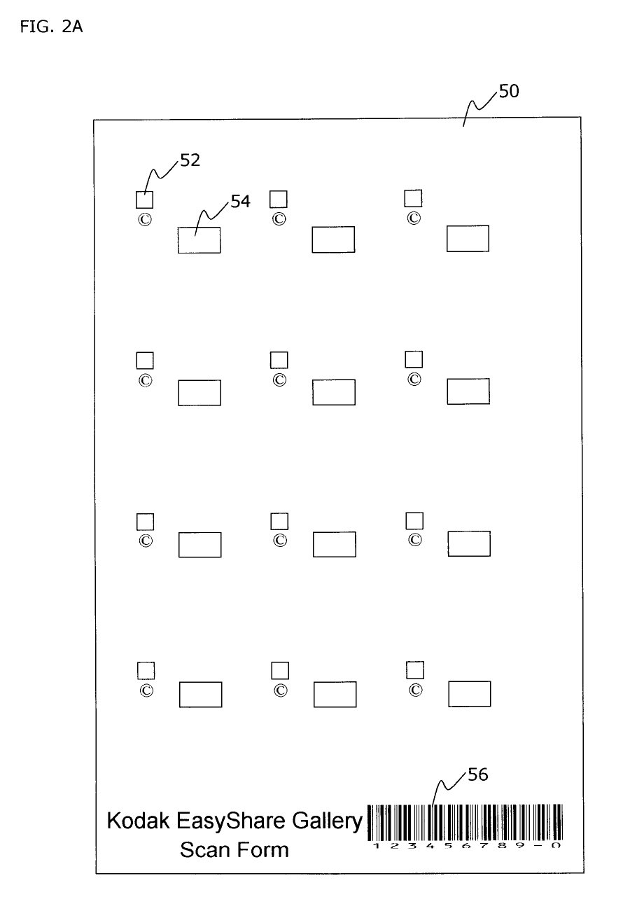

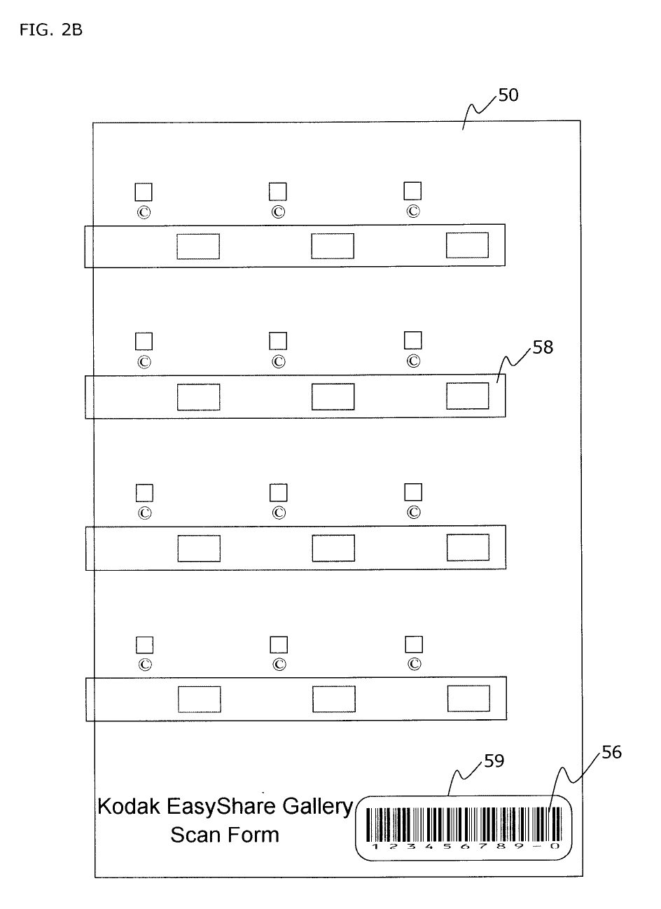

FIG. 2A is one embodiment suitable for affixing multiply hard copy images onto a sheet for scanning. In FIG. 2A, a scan sheet 50 suitable for affixing multiple hard copy images for scanning is shown. The sheet includes a bar code 56 for providing information identifying an individual user account. Scan sheet 50 further includes information for identifying each individual image file as a copyrighted image file. This identification information can be illustrated as a box 52. However, the embodiment is not limited to a box 52, and any suitable identifier can be used, such as a field, selection box, adhering an icon, providing a stamp or punch-out, etc. Scan sheet 50 also includes a box 54 that indicates the placement position of an individual hard copy image. Accordingly, hard copy images 16 are affixed to the sheet with the application of adhesive, preferably temporary, applied by a user. However, the invention is not limited to the temporary adhesive and any other suitable technique of affixing the hard copy images 16 to scan sheet 50 can be used, such as permanent adhesive, clips, tape, slots made in the scan sheet 50, clear plastic covers, etc.

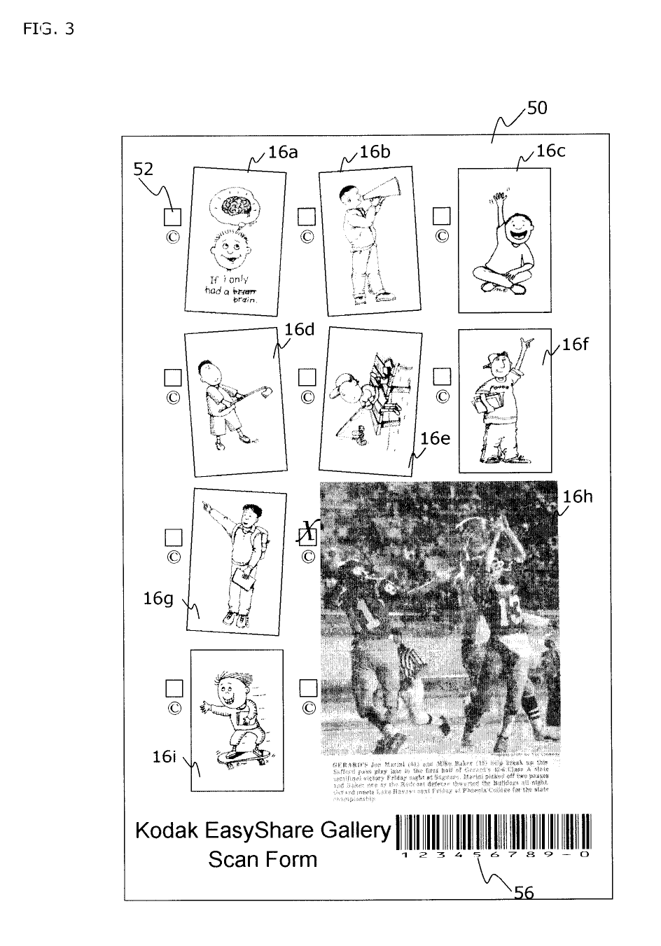

FIG. 2B illustrates an alternative arrangement of a scan sheet suitable for affixing multiple hard copy images. In FIG. 2B, the scan sheet 50 has pre-applied adhesive in box 54 that is covered with a removable barrier 58. Prior to positioning a hard copy image 16 on scan sheet 50, the removable barrier 58 is removed by the user. It should also be noted that box 54 does not limit the size of the individual hard copy image to be placed thereon. As will be shown in FIG. 3, hard copy images 16 of various sizes can be placed on scan sheet 50 without affecting the scope of the embodiment. In another embodiment, scan sheet 50 is a uniform color (non-white) such as green to assist the controlling computer 12 in identifying one or more images from the scanned image data using a technique commonly used in the production of video material, known as “green screen”.

Scan sheet 50 can be stored on personal computer 18 as a template and printed on a local printer such as an ink jet printer. Preferably, the raw paper stock for printing the sheet is a uniform color such as green, but optionally the uniform color can be printed as a background. Similarly, such a template for the sheet can be stored at retailer 15 on controlling computer 12 or at the online service provider 26 on server 24.

The printing of the scan sheet 50 also includes printing box 52, which can be a selection box that is selected to indicate copyrighted material. Also the printing of scan sheet 50 includes printing box 54, in addition to the bar code 56 for providing information identifying an individual user account. The information identifying an individual user account can be downloaded from online service provider 26 and merged with the template for printing. Alternatively, the information identifying an individual user account can be printed on a label 59 and adhered to the scan sheet 50 prior to a scanning session. The individual user account can be associated with the online service provider 26, a storage network (not shown) or a remote drive on a peer-to-peer network (not shown). The individual user account typically requires a username in combination with a secure password to authenticate with the online service provider 26 or the network storage facility.

If the scan sheet 50 is printed remotely from the user associated with the identified individual user account, it can be delivered to the user prior to a session where scan sheet 50 is used for affixing hard copy images to be scanned. Delivery can include, but not be limited to, postal mail, shipping services, or hand delivery.

FIG. 3 illustrates a plurality of hard copy images affixed to a sheet. In FIG. 3, scan sheet 50 is shown with a plurality of hardcopy images 16a-16i affixed thereon. Bar code 56 encodes the information identifying an individual user account. The bar code 56 can also be a link to a memory location that stores information identifying the individual user account. While the user can attempt to place hard copy images 16 in orthogonal alignment on scan sheet 50, it is not necessary to do so. Conventional software controlling the scanner can find the edges of each photograph and straighten out the image. This will be discussed further with respect to FIG. 6. As shown in FIG. 3, there are eight (8) hard copy images that are too small to be handled individually, and one hard copy image 16h which is large enough to be handled individually, but not durable or rigid enough to be fed into a scanner. Furthermore, image 16h is a copyrighted image belonging to a newspaper, a news photographer, or a news wire service. As such, the scanner operator has marked box 52 near the newspaper hard copy image.

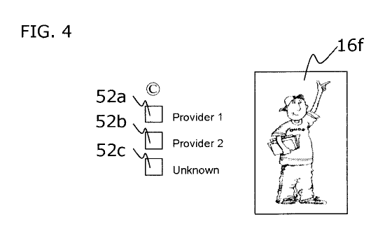

FIG. 4 is an alternative embodiment for providing information identifying copyrighted image files. In FIG. 4, hard copy image 16f is shown as an alternative arrangement for providing information for identifying individual image 16f as a copyrighted image. Boxes 52a, 52b, and 52c indicate the copyright owners. The boxes can be any suitable indicator such as, but not limited to, a field, sticker, pull-tab, hole punch, etc. Selecting one or more of the boxes 52a, 52b by an operator, designates the copyright owner(s) for the image 16f. Box 52c specifically provides a selection area for selecting an “unknown” copyright owner and allows a payment for use of the copyrighted material to be made to a general fund for the benefit of all copyright owners.

Often a human readable watermark is present on either the image bearing side or the non-image bearing side of a hard copy image. If there is no human readable watermark available on any surface of the hard copy image, box 52c is marked by the operator. It is possible that the image area has an embedded watermark that can be automatically identified during the scanning process. The embedded watermark can be identified using a technique found in commercially available software, such as Adobe PhotoShop from Adobe Inc. This will be discussed in the following paragraphs.

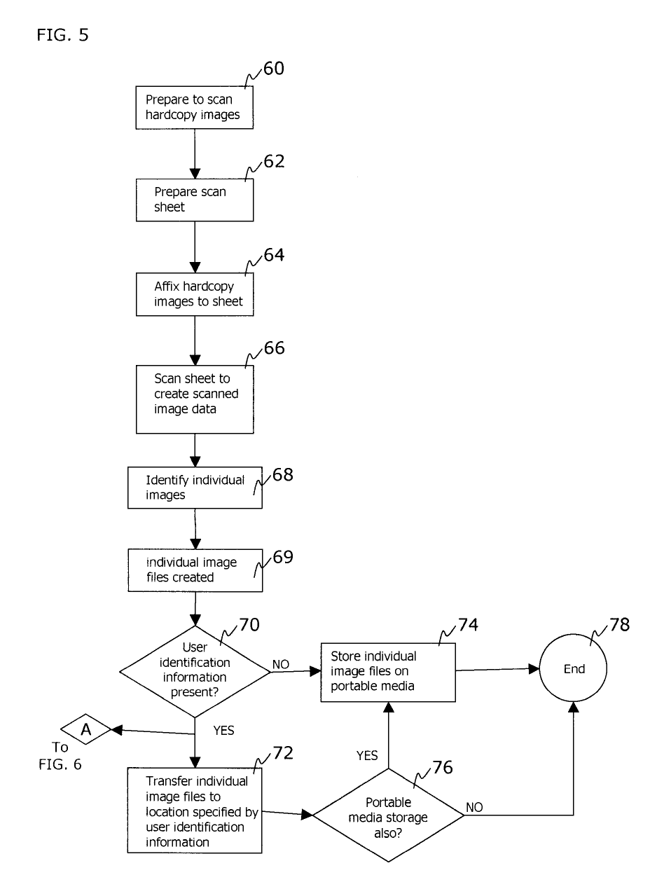

FIG. 5 illustrates a flow chart for automatically scanning hard copy images affixed to a sheet. In FIG. 5, the user prepares to scan small hardcopy images on scan sheet 50 (step 60). The scan sheet is prepared by either using a generic scan sheet 50, printing the template with information identifying an individual user account, or printing label 59 with the same information and affixing the label to the scan sheet 50 (step 62). Next, the user affixes hardcopy images 16 to the scan sheet 50 in the one or more areas as indicated by the box 54 using a temporary adhesive such as glue or tape 64. When the hardcopy images 16 are properly affixed, scan sheet 50 is presented to a scanner operator for scanning. It is at this point that the scanner operator reviews the hardcopy images 16 and marks scan sheet 50 in the associated box 52 for each image that is a copyrighted image. It should be noted that in a home setting, the scanner operator is typically the user who operates the personal computer 18 and flatbed scanner 20 as illustrated in FIG. 1.

Scanned image data is created by scanning a sheet with affixed hard copy images 16 (step 66). The process of scanning a physical medium to convert it to digital data for further image processing is well understood by those skilled in the art. Individual hardcopy images 16 are identified or sensed within the scanned image data using automatic frame detection algorithms 68. In the one embodiment, scan sheet 50 is formed from paper stock of a uniform non-white color such as green to facilitate the image processing that determines the location of individual images. However, the embodiment is not limited to green paper stock, and any suitable color can be used. However, while a uniform white paper stock will work, it is more difficult to detect the edges of bounding rectangles that also have white borders.

For each identified image within the scanned image data, individual image files are created in a default image file format such as, but not limited to, a JPEG format. Such preferences can be changed by the user as required 69. Information identifying an individual user account, copyright information including the copyright owner, and other information, such as information gathered using face recognition software, can be stored as metadata in association with each individual image file. After individual images files have been created, they can be stored. In one embodiment, information identifying an individual user account is provided on scan sheet 50 in the form of printed bar code 56, or label 59 that includes printed bar code 56 and/or other information. If this information is determined to be present in the scanned image data 70, then the individual image files are transferred 72 to the location specified by the information encoded by bar code 56 and optionally also stored on any portable media such as CD media 76. If identification information is not present or is not able to be successfully interpreted, the individual image files are stored on any media that the user chooses 74 and the process is complete 78. If no copyrighted images are found during the scanned image data processing, the process completes 78.

When the user intends to scan multiple small, hard copy images that include copyrighted images, the scanned image data must be checked for information for identifying each individual image file as a copyrighted image file prior to storing the image files in any specific location or medium 72, 74.

FIG. 6 is a flowchart illustrating the presence of user identification information. In FIG. 6, the scanned image data is checked for information identifying each individual image file as a copyrighted image file 80. The scanned image data is checked for information provided in box 52 by an operator and is therefore a form of human readable mark. If the scanned image data does not reveal any human readable marks, the scanned data is then checked for copyright information embedded in each individual image file identifying each individual image file as a copyrighted image file 81.

Each image file determined to be a copyrighted image file is automatically tagged 82 as a high resolution, restricted image file and a low resolution copy of each high resolution, restricted image file is formed 84. These low-resolution copies of associated high-resolution, restricted image files are subsequently transferred 86 to the location encoded in the information identifying an individual user account found in bar code 56. It is useful to transfer the high-resolution, restricted image files to a location controlled by the online service provider 26 for restricting access to these images until payment has been provided by the user 88. To complete the process 94, the user can store copyrighted image files on a portable media of choice 90. However, only the low-resolution copies are stored 92 on the portable media of choice.

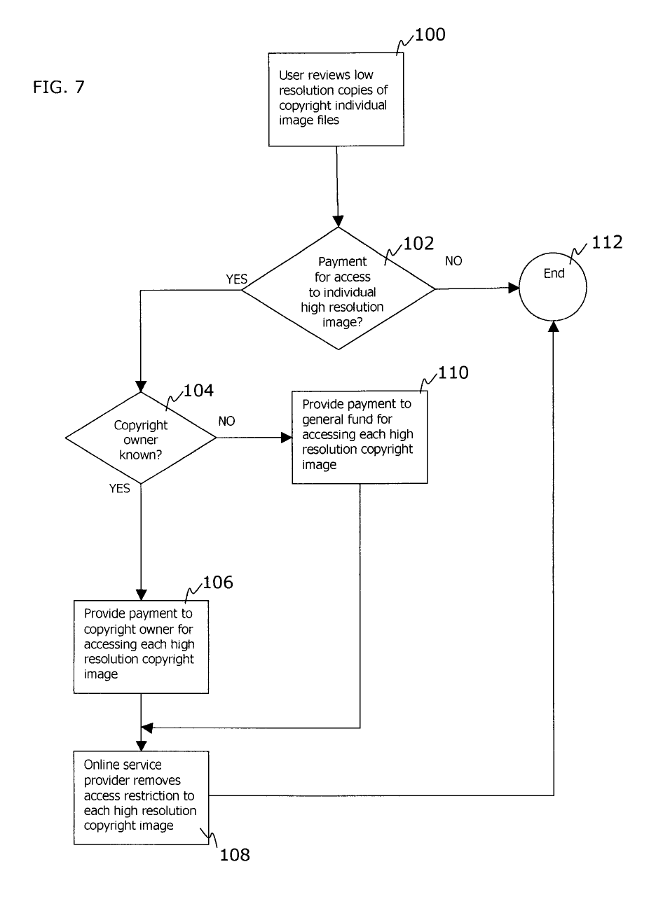

FIG. 7 is a flowchart illustrating the viewing of copyrighted individual image files. At some point, the user is viewing 100 the transferred low-resolution copies of high-resolution, copyright image files while connected to the online service provider 26. The user decides to provide payment for access rights to the high-resolution, copyrighted individual image files 102. The online service provider 26 determines the copyright owner from the metadata associated with the file 104. The user then provides payment for accessing each high-resolution copyright file either connecting directly to the copyright owner 106, a commercial proxy for the copyright owner or a general fund 110, which benefits copyright owners in the event that the copyright owner is not known or available for payment. Upon completion of payment, the process ends 112 when the online service provider 26 removes the access restriction to each high-resolution copyright image 108. Removal of access restriction preferably involves replacing the low-resolution copies with the associated high-resolution image file.

The automated scanning of hard copy images can also be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed in desired in various embodiments.

Also, processing devices attached to a communications network typically includes at least some form of computer readable media. Computer readable media can be any available media that can be accessed by these devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by processing devices.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

Additionally, the embodiments described herein are implemented as logical operations performed by programmable processing devices. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

The various embodiments described above are provided by way of illustration only and should not be construed to limit the invention. Those skilled in the art will readily recognize various modifications and changes that can be made to the present invention without following the example embodiments and applications illustrated and described herein, and without departing from the true spirit and scope of the present invention, which is set forth in the following claims.

### PARTS LIST

10 system
12 computer
14 high speed scanner
15 retailer
16 hardcopy images
16a-16i hardcopy images
16f alternative hardcopy image
16h large hardcopy image
18 personal computer
20 flatbed scanner
22 communication network
24 server
26 on-line service provider
28 copyright owners
30 servers
32 copyright owners
34 servers
50 scan sheet
52a, 52b, 52c boxes
54 box
56 bar code
58 removable barrier
59 printing label
60 prepare to scan image
62 affix label to scan sheet
64 glue or tape
66 scanned image data
68 algorithms
69 image files created
70 user ID
72 image file location specified
74 stored file on portable media
76 media storage
78 process complete
80 copyrighted image file
81 embedded copyrighted image file
82 tagged copyrighted image file
84 created image file
86 transferred restricted image files
88 user
90 portable media
92 low resolution copies
94 process
100 user viewing copyright image files
102 payment for files
104 identify copyright owner
106 payment to copyright owner
108 access restriction removed
110 provide payment
112 end process

We claim:

1. A method for scanning multiple images, comprising:
affixing one or more images to a sheet;
scanning the sheet to create scanned image data;
identifying the one or more images from the scanned image data; and
creating an individual image file for each of the one or more identified images in the scanned image data.

2. The method of claim 1, wherein creating the individual image file further comprises storing the individual image file on a portable media.

3. The method of claim 1 further comprising:
providing user identification information for identifying a location of user image file storage for storing the individual image file;
scanning the user identification information; and
transferring the individual image files to the location specified by the scanned user identification information.

4. The method of claim 1 further comprising determining that the each individual image file is copyrighted.

5. The method of claim 4 wherein the determining further comprises determining the presence of a watermark embedded in the image.

6. A method for printing a sheet suitable for scanning multiple images, comprising:
providing a template for forming a sheet for affixing and scanning multiple hard copy images;
providing information identifying an individual user account;
printing the sheet using the template; and
printing the information identifying the individual user account.

7. The method of claim 6 further comprising providing an adhesive area for affixing hard copy images to the sheet.

8. The method of claim 6 further comprising delivering the printed sheet to a user associated with the identified individual user account.

9. The method of claim 6 wherein printing information identifying the individual user account further comprises printing information on an adhesive label to be applied to the sheet.

10. The method of claim 6 further comprising associating the individual user account with an online service provider.

11. The method of claim 6 further comprising associating the individual user account with a network.

12. The method of claim 6 further comprising associating the individual user account with a peer-to-peer network.

13. The method of claim 6 further comprising creating an individual image file for each of the scanned hard copy images;
providing information for identifying each individual image file in the individual user account as a copyrighted image file; and
restricting user access to each identified copyrighted image file.

14. The method of claim 13, wherein restricting user access further comprises providing access to a low-resolution copy of each identified copyrighted image file.

15. The method of claim 13 further comprising providing payment for accessing each identified copyrighted image file.

16. The method of claim 13, wherein the providing information for identifying each individual image file as a copyrighted image file further comprises indicating that the individual image file is a copyrighted image prior to scanning the sheet.

17. A system for scanning multiple images, comprising:
a sheet for affixing one or more images;
a scanner for sensing data on the sheet and converting the data into scanned image data; and
a processor coupled to the scanner for identifying the one or more images from the scanned image data and creating an individual image file for each of the one or more identified images.

18. The system of claim 17 further comprises a memory for storing the individual image file on a portable media.

19. The system of claim 17 further comprising user identification information for identifying a location of user image file storage for storing the individual image file and transferring the individual image file to the location specified by the user identification information.

20. The system of claim 17 further comprising an adhesive area for affixing hard copy images to the sheet.

21. The system of claim 20 further comprising an adhesive label for printing information identifying the individual user account.

22. The system of claim 21 wherein the individual user account is associated with an online service provider.

23. The system of claim 21 wherein the individual user account is associated with a network.

24. The system of claim 21 wherein the individual user account is associated with a peer-to-peer network.

25. The system of claim 17 further comprising information for identifying each individual image file as a copyrighted image file and restricting user access to each identified copyrighted image file.

26. The system of claim 25 further comprising a low-resolution copy of each identified copyrighted image file.

27. The system of claim 25 further comprising a payment for accessing each copyrighted image file.

28. The system of claim 17 further comprising a watermark embedded in the individual image file.

29. A program storage device readable by a computer, tangibly embodying a program of instructions executable by the computer to perform the method steps for causing a scanning of multiple images on scan sheet, comprising:
affixing one or more images to a sheet;
scanning the sheet for creating scanned image data;
identifying the one or more images from the scanned image data; and
creating an individual image file for each of the one or more identified images in the scanned image data.
